(19) United States
(12) Patent Application Publication
(10) Pub. No.: US 2025/0258812 A1
(43) Pub. Date: Aug. 14, 2025

(54) RAPID INTERACTIVE ITERATION FOR PROMPT DESIGN

(71) Applicant: Scaled Cognition, Inc., Amesbury, MA (US)

(72) Inventor: Mathew Gardner, Irvine, CA (US)

(73) Assignee: Scaled Cognition, Inc., Amesbury, MA (US)

(21) Appl. No.: 18/908,222

(22) Filed: Oct. 7, 2024

Related U.S. Application Data
(60) Provisional application No. 63/551,535, filed on Feb. 9, 2024.

(51) Int. Cl. G06F 16/242

(52) U.S. Cl. CPC G06F 16/2428

(57) ABSTRACT

A system provides a rapid, interactive utility for rendering and optimizing a prompt for input into an LLM. A user interface allows a user to select and modify several prompt parameters, including but not limited to prompt format, selecting external content that can be dynamically retrieved, style of mark-up, and other aspects of a prompt. The utility renders a prompt based on user selection and modification of the parameters. The dynamic content within the prompt can include instructions for performing a task and examples of previous input data (e.g., prompts) and desired outputs by an LLM. Once an output is provided by an LLM in response to a rendered prompt, the prompt and output can be evaluated against one or more examples of similar prompts and high scoring outputs. The current prompt can then be optimized based on the evaluation to improve evaluation score metrics for the prompt.

### CROSS REFERENCE TO RELATED APPLICATIONS

The present application claims the priority benefit of U.S. provisional patent application 63/551,535, filed on Feb. 9, 2024, titled “Rapid Interactive Iteration for Prompt Design,” the disclosure of which is incorporated herein by reference.

### BACKGROUND

A large language model (LLM) receives a prompt as input, processes the prompt, and provides an output in response to the prompt. The output of an LLM can vary widely based on the prompt. In fact, multiple prompts having different formats and content, while asking the LLM to perform a single task, typically receive different outputs. Typically, to modify a prompt, a human will make slight changes to a prompt, using trial and error techniques, to get a desired output. This manual process to try to modify a prompt to get a more reliable or accurate output is time consuming and unreliable. What is needed is an improved method for modifying a prompt to obtain a more trustworthy output.

### SUMMARY

The present technology, roughly described, provides a rapid, interactive utility for rendering and optimizing a prompt for input into an LLM. A user interface allows a user to select and modify several prompt parameters, including but not limited to prompt format, selecting external content that can be dynamically retrieved, style of mark-up, and other aspects of a prompt. The utility renders a prompt based on user selection and modification of the parameters. The dynamic content within the prompt can include instructions for performing a task and examples of previous input data (e.g., prompts) and desired outputs by an LLM. Once an output is provided by an LLM in response to a rendered prompt, the prompt and output can be evaluated against one or more examples of similar prompts and high scoring outputs. The current prompt can then be optimized based on the evaluation to improve evaluation score metrics for the prompt.

In some instances, the present technology performs a method for rendering a prompt. The method begins with providing, by a server, an interface for configuring a set of parameters used to render a prompt, wherein the prompt can be submitted to a machine learning model provided by one or more remote servers. A selection is received to modify at least one parameter within the interface. The prompt is then rendered from the set of parameters with at least one modified parameter, wherein a plurality of the parameters are used to format the prompt but are not directly entered into the prompt.

In some instances, the present technology includes a non-transitory computer readable storage medium having embodied thereon a program, the program being executable by a processor to perform a method for rendering a prompt. The method begins with providing, by a server, an interface for configuring a set of parameters used to render a prompt, wherein the prompt can be submitted to a machine learning model provided by one or more remote servers. A selection is received to modify at least one parameter within the interface. The prompt is then rendered from the set of parameters with at least one modified parameter, wherein a plurality of the parameters are used to format the prompt but are not directly entered into the prompt.

In some instances, the present technology includes a system having one or more servers, each including memory and a processor. One or more modules are stored in the memory and executed by one or more of the processors to provide, by a server, an interface for configuring a set of parameters used to render a prompt, the prompt to be submitted to a machine learning model provided by one or more remote servers, receive a selection to modify at least one parameter within the interface; and render the prompt from the set of parameters with at least one modified parameter, wherein a plurality of the parameters are used to format the prompt but are not directly entered into the prompt.

### BRIEF DESCRIPTION OF FIGURES

FIG. 1 illustrates a block diagram of a system for rendering a prompt.

FIG. 2 illustrates a block diagram of a prompt application.

FIG. 3 illustrates a block diagram showing data flow for a system that automatically renders a prompt.

FIG. 4 illustrates data flow for a machine learning model.

FIG. 5 illustrates a method for automatically rendering and optimizing a prompt.

FIG. 6 illustrates a method for populating configuration parameters for a selected node.

FIG. 7 illustrates a method for receiving an input provided to a user interface.

FIG. 8 illustrates a method for rendering a prompt for a selected state.

FIG. 9 illustrates a method for determining and retrieving examples based on input and attributes.

FIG. 10 illustrates a method for evaluating input and output.

FIG. 11 illustrates a method for optimizing a prompt.

FIG. 12 illustrates an interface for selecting a state within a state machine associated with an interaction between an automated agent and a customer.

FIG. 13 illustrates an interface associated with a selected state.

FIG. 14 illustrates a prompt associated with a selected state.

FIG. 15 illustrates an interface displaying a set of examples associated with a current input and output.

FIG. 16 illustrates an interface with a subset of selected examples associated with a current input and output.

FIG. 17 illustrates an interface for optimizing a prompt.

FIG. 18 illustrates another interface for optimizing a prompt.

FIG. 19 illustrates an evaluation comparison report.

FIG. 20 illustrates an interface with selected examples for optimizing a prompt.

FIG. 21 illustrates a computing environment for implementing in the present technology.

### DETAILED DESCRIPTION

The present technology, roughly described, provides a rapid, interactive utility for rendering and optimizing a prompt for input into an LLM. A user interface allows a user to select and modify several prompt parameters, including but not limited to prompt format, selecting external content that can be dynamically retrieved, style of mark-up, and other aspects of a prompt. The utility renders a prompt based on user selection and modification of the parameters. The dynamic content within the prompt can include instructions for performing a task and examples of previous input data (e.g., prompts) and desired outputs by an LLM. Once an output is provided by an LLM in response to a rendered prompt, the prompt and output can be evaluated against one or more examples of similar prompts and high scoring outputs. The current prompt can then be optimized based on the evaluation to improve evaluation score metrics for the prompt.

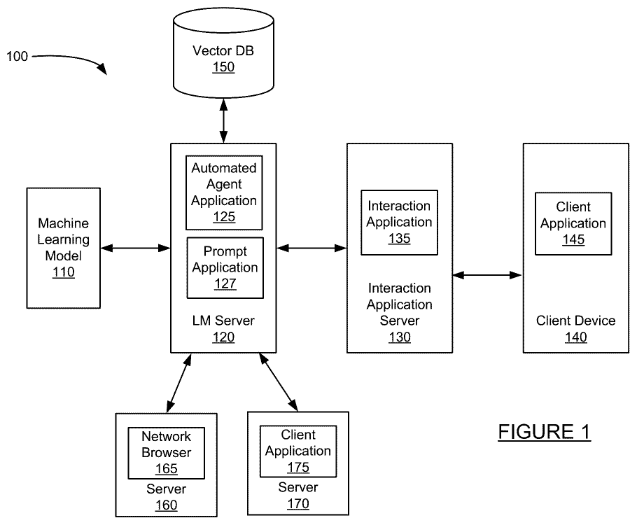

FIG. 1 is a block diagram of a system for rendering a prompt. The system of FIG. 1 includes machine learning model 110, language model server 120, interaction application server 130, client device 140, vector database 150, server 160 and server 170.

Machine learning model 110 may include one or more models or prediction engines that may receive an input, process the input, and provide an output based on the input. In some instances, machine learning model (LM) 110 may be implemented on one or more servers implementing language model server 120. In some instances, machine learning model 110 may be implemented by a large language model (LLM), on one or more servers external to LM server 120. Machine learning model 110 may be implemented as one or more models, on one or more machines, and in one or more environments.

Language model server 120 may be implemented as one or more servers that implement one or more automated agent applications 125 and prompt application 127. Application 125 may provide an automated agent that provides dialogue through chat application 125 on server 130, and interacts with a customer associated with client device 140.

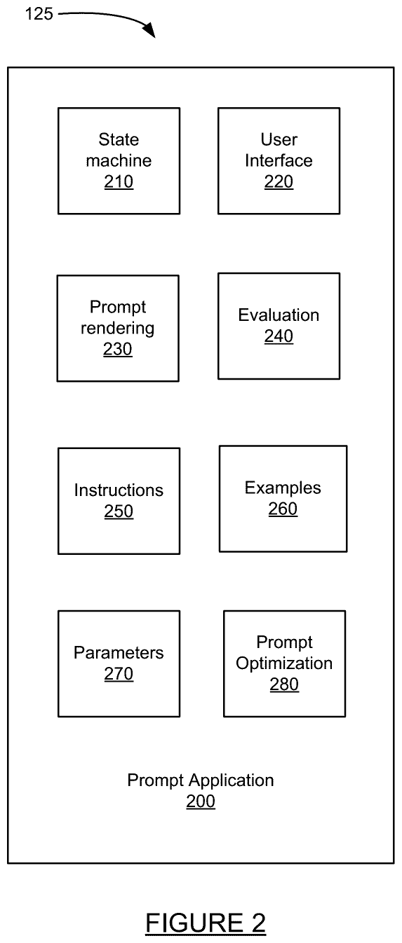

Prompt application 127 may render a prompt to be submitted to an LLM. The prompt application may provide a user interface that receives tributes for several parameters that can be used to render a prompt. In some instances, the prompt application can provide a different set of parameters for each state in the state machine followed by the automated agent application. The prompt application may render the prompt, including dynamic generation of instructions and examples, evaluate the level of success of the rendered prompt, and then automatically modify the current prompt based on the evaluation. More details for prompt application 127 are discussed with respect to FIG. 2.

In some instances, interaction application server 130 may facilitate an interaction, such as for example a text conversation, between an automated agent provided by server 120 and a client on client device 140. Interaction application 135 on server 130 may communicate with the automated agent and other applications from server 120 and client application 145 to provide an interaction. The interaction may include a text or audio conversation between the automated agent and the client, which may be provided in real time to both the client device and server 120 through one or more interfaces.

Client device 140 may be implemented as a machine remote from server 130 may be associated with a client engaged in an interaction with an automated agent through interaction application server 130. Client device 140 may include a client application 145, implemented as, for example, a mobile app, computer program, or some other software.

Vector database 150 may be implemented as a data store that stores vector data. In some instances, vector database 150 may be implemented as more than one data store, internal to system 100 and exterior to system 100. In some instances, a vector database can serve as an LLMs' long-term memory and expand an LLMs' knowledge base. Vector database 150 can store private data or domain-specific information outside the LLM as embeddings. Vector database 150 may include data such as prompt templates, instructions, training data, and other data used by LM application 125 and machine learning model 110.

In some instances, the present system may include one or more additional data stores, in place of or in addition to vector database 150, at which the system stores searchable data such as instructions, private data, domain-specific data, and other data.

Prompt application 127 can provide an interface for managing parameters for rendering a prompt. The interface can be provided to a user through a network browser 165 on server 160, a client application 175 on server 170, or through some other application. The network browser can receive and load content pages provided by prompt application 127. The content pages can include the interface for managing and setting the parameters, submitting the prompt, performing an evaluation of the prompt and resulting input, and optimizing the prompt. Client application 175 can communicate with prompt application 127 to provide an interface to a user through server 170. A user may interact with the client application interface to manage and set prompt parameters, submit the prompt, evaluate the prompt and resulting input, and optimize the prompt.

Each of model 110, servers 120-130 and 160-170, client device 140, and vector database 150 may communicate over one or more networks. The networks may include one or more the Internet, an intranet, a local area network, a wide area network, a wireless network, Wi-Fi network, cellular network, or any other network over which data may be communicated.

In some instances, one or more of machines associated with devices and/or machines 110-170 may be implemented in one or more cloud-based service providers, such as for example AWS by Amazon Inc, AZURE by Microsoft, GCP by Google, Inc., Kubernetes, or some other cloud based service provider.

The system of FIG. 1 illustrates a language model application within an interaction system formed with ML model 110, LM server 120, and client device 140. Illustration of the language model in an interaction or automated agent system is for purposes of discussion only, and the language model of the present technology is not intended to be limited to interaction systems alone.

FIG. 2 is a block diagram of a prompt application. Prompt application 200 of FIG. 2 provides more detail for prompt application 127 of FIG. 1. Prompt application 200 include state machine 210, user interface 220, prompt rendering 230, evaluation 240, instructions 250, examples 260, and parameters 270.

State machine 210 may be used by automated agent application 125 2process requests through an interaction with a customer. The state machine may control the logical flow of the automated agent as it processes user requests and interacts with a customer through interaction application 125 on server 130.

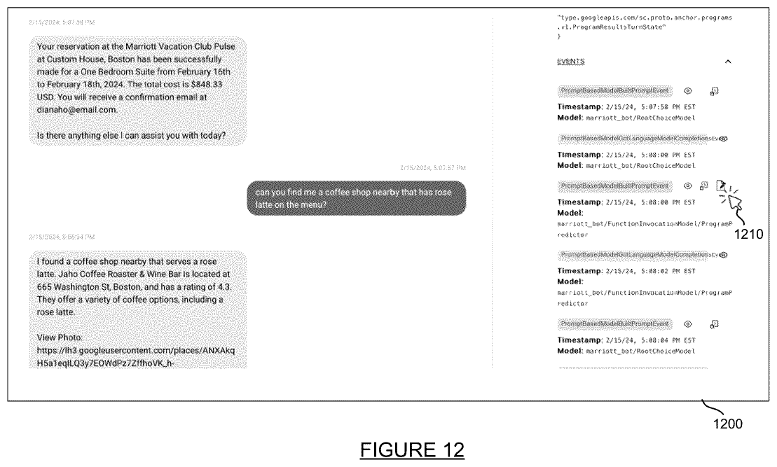

User interface 220 may render and provide a graphical interface to a user for rendering a prompt, submitting a prompt to an LLM, evaluating a prompt, and optimizing a prompt. The interface 220 may be implemented as a graphical interface and be provided through a network browser application, a client application, or some software. The graphical interface may have a plurality of parameters that may be selected and managed by a user through radio buttons, slide bars, drop down boxes, text boxes, check boxes, and other interactive elements. In some instances, a set of parameters can be provided in the interface for different states in the state machine. The interface parameters can be populated automatically by prompt rendering module 230 or in response to input received from a user through the interface. The user interface is not a prompt text editor—the parameters set forth in a prompt are not direct text modifications to a prompt. Rather the parameter values and content are used to guide the present system to render a prompt. Examples of user interfaces are provided with respect to FIGS. 12-20.

Prompt rendering 230 may render a prompt for an LLM based on parameters specified through user interface 220. Prompt rendering 230 may retrieve instructions, retrieve examples, display instructions and examples, markup the prompt, express a task, format sections of the prompt, and perform other formatting and generation tasks to the prompt based on parameters specified in the graphical interface.

In addition to examples and instructions, prompt rendering may access content such as conversation history, invoked programs, and other content in order to render a prompt. A rendered prompt may include one or more requests, interaction history, and optionally other data. The request may indicate what the large language model is requested to do, for example determine a probability that each of several tokens is the best token, determine a next state from the current state, determine a response for a user inquiry, select a function or program to be executed, perform an audit of a predicted response, or some other goal.

Evaluation module 240 may evaluate the LLM output provided by an LLM that received and processed the rendered prompt. To evaluate an input and output, the evaluation module 240 can compare the prompt and the corresponding LLM output to an example input (e.g., prompt) and output. The evaluation module can generate evaluation report with metrics to score the evaluation, such as for example coherence, contextual understanding, and a fence score. Based on the evaluation report, prompt optimization 280 may automatically optimize the prompt.

Instructions 250 may include one or more instructions retrieved by prompt rendering module 230 to include in the rendered prompt. The instructions may be retrieved from vector database 150 or some other data store, local or remote from server 120. The instructions are retrieved based on instruction related parameters within user interface 220. Instruction related parameters can include the number of instructions to retrieve, how to select instructions to retrieve, how to display the instructions, and how to order the instructions within the rendered prompt.

Examples 260 may include one or more examples retrieved by prompt rendering 230 to include tin the rendered prompt. The examples may be retrieved from vector database 150 or some other data store, local or remote from server 120. The examples can be retrieved based on example related parameters in the user interface, and may include an example input and output to include within the prompt for submission to a language model. In some instances, the examples can be retrieved to perform an evaluation of the rendered prompt and the output. Example related parameters can include the number of examples to retrieve, how to select the examples, whether the examples are used in the prompt, for evaluation, or both, how to display the examples in the prompt, and how to order the examples within the rendered prompt.

Parameters 270 may be stored locally at server 120 or remotely at vector database 150 or some other data store. The parameters may set forth in the user interface and can specify aspects of a prompt to be rendered. Examples of parameters can include how many tokens to include in the prompt, what language to user for a program in the input, portions of the prompt to keep in all capitals, a temperature parameter, which LLM to use, and other parameters.

Prompt optimization 280 can optimize prompt rendering parameters based on an evaluation performed by evaluation module 240. Prompt optimization can occur by searching through a stored set of prompt formats, such as for example a particular collection of parameters having different values. In some instances, different formats of prompts can include different sets of parameters, for example a set of parameters used for different states. In some instances, the prompt optimization generates free text for the prompt rather than searching a finite set of prompt format candidates.

The search for prompt formats can be guided by the evaluation report generated by evaluation module 240. For example, the prompt evaluation module 280 can user reinforcement learning and rely on the evaluation report the computation of a reward function. The prompt optimization can make iterate modifications to the prompt format, with each iteration being scored by an evaluation report, to enable rapid automated prompt improvement. In some instances, each variation of the prompt throughout the iterative process can be viewed by a user in the user interface.

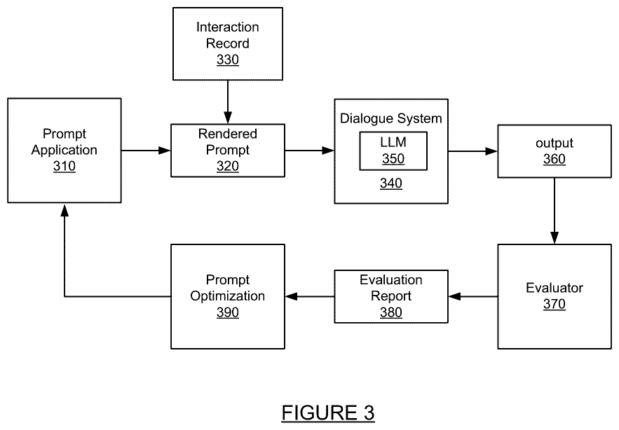

FIG. 3 is a block diagram showing data flow for a system that automatically renders a prompt. Prompt application 310 generates a rendered prompt 320. The rendered proper 320 is generated based on parameters specified in a user interface provided to a user by prompt application 310. The rendered prompt 320 may also include all or a portion of an interaction record 330 between automated agent application 125 and a customer associate with client application 145. The interaction record 330 can include text exchanges in the interaction between the agent and the client application, functions called, responses generated, and other logic and content. The rendered prompt is provided to a dialogue system 340. The dialogue system provides the rendered prompt to a machine learning model, such as a large language model 350.

Model 350 generates an output 360, which is then accessed by evaluator 370. The evaluator compares the output and rendered prompt to example inputs and outputs and generates an evaluation report 380.

The evaluation report is received by prompt optimization 390 and used to evaluate the rendered prompt and LLM output. Prompt optimization 390 receives the report, performs a search for available prompt templates based on the evaluation report, and optimizes the prompt parameters based on the evaluation report. In some instances, a user can indicate what parameters may be optimized based on the evaluation report.

The blocks of data flow diagram of FIG. 3 are separated for purposes of discussion. It is intended that the blocks of FIG. 3 can be combined, kept separate, or separated further. For example, evaluator 370 and prompt optimization 390 may be implemented within prompt application 310, rather than separately from application 310.

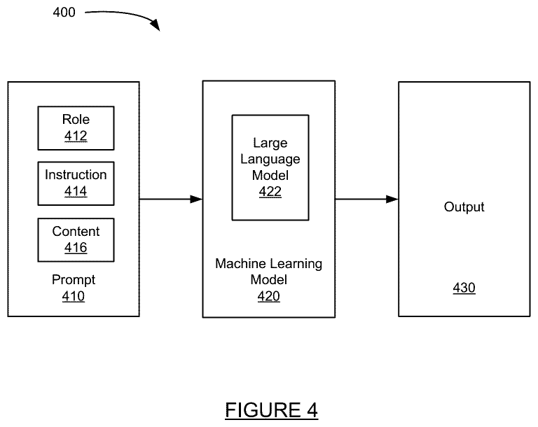

FIG. 4 illustrates data flow for a machine learning model. The block diagram of FIG. 4 includes prompt 410, machine learning model 420, and output 430.

Prompt 410 of FIG. 4 can be provided as input to a machine learning model 420. A prompt can be rendered by a prompt rendering module and can include information or data such instructions 414 and content 416, as well as other content such as examples.

Instructions 414 can indicate what the machine learning model (e.g., a large language model) is supposed to do with the content provided in the prompt. For example, the machine learning model instructions may request, via instructions 414, an LLM to predict a probability that a particular token is the next token in a sequence of tokens, determine if a predicted response was generated with each instruction followed correctly, determine what function to execute, determine whether or not to transition to a new state within a state machine, and so forth. The instructions can be retrieved or accessed from document 155 of vector database 150, locally at a server that communicates or hosts the machine learning model, or from some other location.

Content 416 may include data and/or information that can help a ML model or LLM generate an output. For an ML model, the content can include a stream of data that is put in a processable format (for example, normalized) for the ML model to read. For an LLM, the content can include sequences of tokens, a conversation between an agent and a user, a grammar, a user inquiry, retrieved instructions, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 420 of FIG. 4 provides more detail for machine learning model 110 of FIG. 1. The ML model 420 may receive one or more inputs and provide an output.

ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data.

In some instances, the present technology may use an LLM such as a BERT LLM, Falcon 30B on GitHub, Galactica by Meta, GPT-3 by OpenAI, or other LLM. In some instances, machine learning model 115 may be implemented by one or more other models or neural networks.

Output 430 is provided by machine learning model 420 in response to processing prompt 410 (e.g., an input). For example, when the prompt includes a request that the machine learning model provide a probability that a particular token is the next token in a sequence, the output will include a probability. The output can be provided to other parts of the present system.

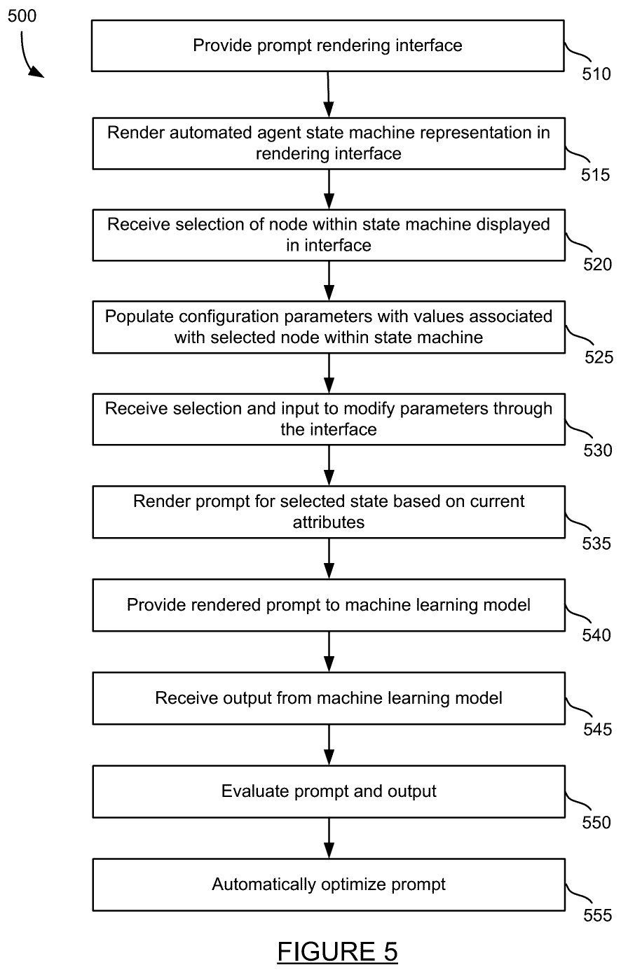

FIG. 5 illustrates a method for automatically rendering and optimizing a prompt. A prompt rendering interface is provided at step 510. Providing the prompt rendering interface may include initializing the interface, and providing interface through a network browser or a client application to a user on server 160.

An automated agent state machine representation is rendered in the interface at step 515. The state machine representation may be displayed as a graph, a series of events, or in some other format, and is based on a state machine used by the automated agent to perform logic and process requests received through an interaction managed by chat application 135. The state machine representation may be rendered on a main page of the interface or available for viewing upon selection by a user of the interface. An interface for providing an agent state machine representation is illustrated in FIG. 12.

Once the state machine graph is provided in the interface, a selection of a node within the state machine is received at step 520. In some instances, the state machine may be represented as a list of events that occurred within an interaction, and the selection may include a selection of an event performed by the automated agent during the interaction. An interface illustrating a selection of an event is illustrated in FIG. 12.

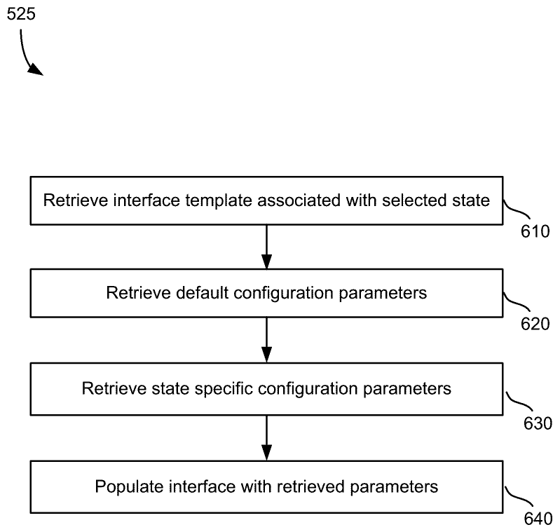

Configuration parameters with values associated with the selected node are populated at step 525. Once a node within the state machine of list of events is selected, the parameters for the selected node or event are populated into the interface. The parameters associated with a state machine may include some parameters included with states, such whether or not to include instructions, whether or not to include examples, and what LLM to submit prompt to. The prompt rendering parameters may also include parameters that may be tailored to specific aspects of the selected state. For example, if a particular state results in either a response being generated or a function performed, one parameter may relate to a format for expressing a function to be executed. Populating configuration parameters within an interface is discussed in more detail with respect to FIG. 6.

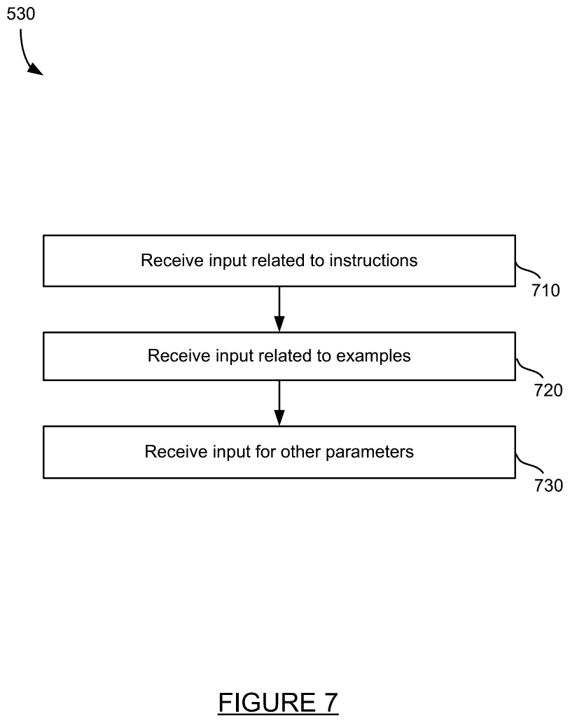

The present system receives selections of parameters and input to edit the selected parameters through the interface at step 530. The parameters being selected and edited can include parameters related to selecting and displaying examples and instructions, an LLM to use, how prompt content is marked up and formatted, temperature, and other parameters. Receiving selections and edits of parameters is discussed in more detail with respect to the method of FIG. 7.

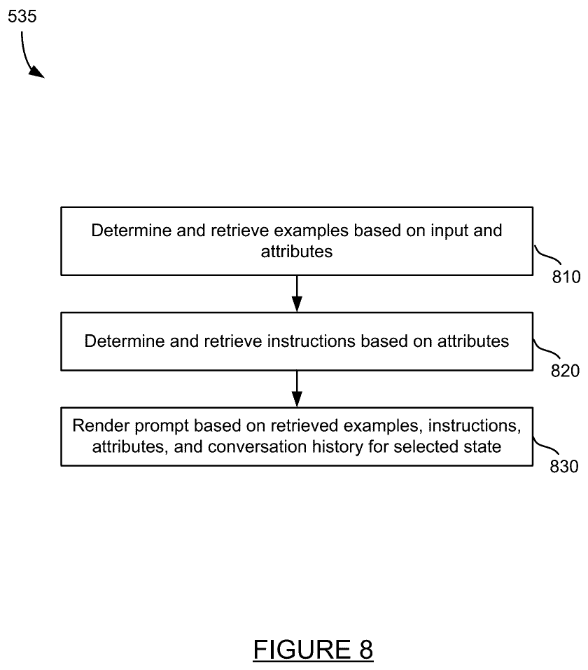

A prompt is rendered for the selected state based on the current parameters at step 535. The prompt is rendered based on the input received at step 530 and the default parameter values associated with the selected state of the state machine or event history. The parameters within the interface are not directly incorporated into the prompt. Rather, the parameters are used by prompt rendering application 230 to render a prompt. Rendering a prompt is discussed in more detail with respect to FIG. 8

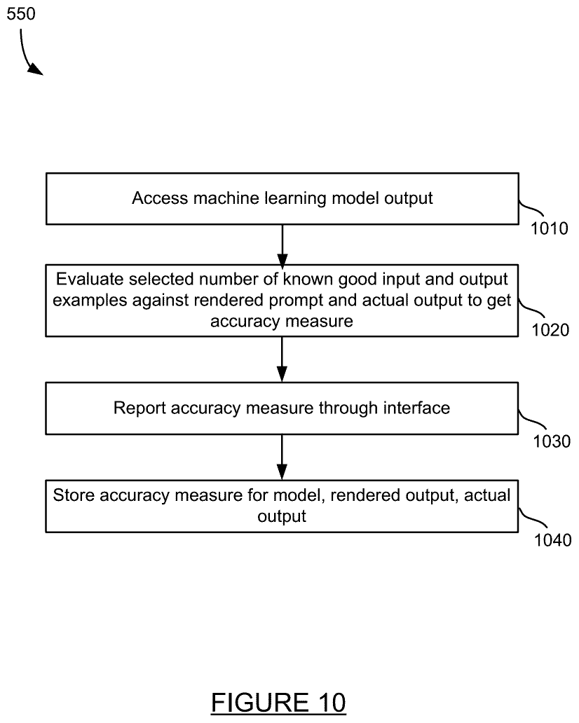

The rendered prompt is provided to a machine learning model at step 540. In some instances, the rendered prompt is provided to a large language model. The machine learning model receives the prompt, processes the prompt, and generates an output. The machine learning model output is then received by the present system at step 545. The prompt and the machine learning model output are then evaluated at step 550. The prompt and output may be evaluated based on examples of an input and output having metric scores that meet a minimum threshold or based on other techniques. In some instances, the example input and output pairs used to evaluate the current prompt and the output are selected based on a high confidence of the output produced by an LLM after processing the example input. Evaluating the prompt and output are discussed in more detail with respect to FIG. 10.

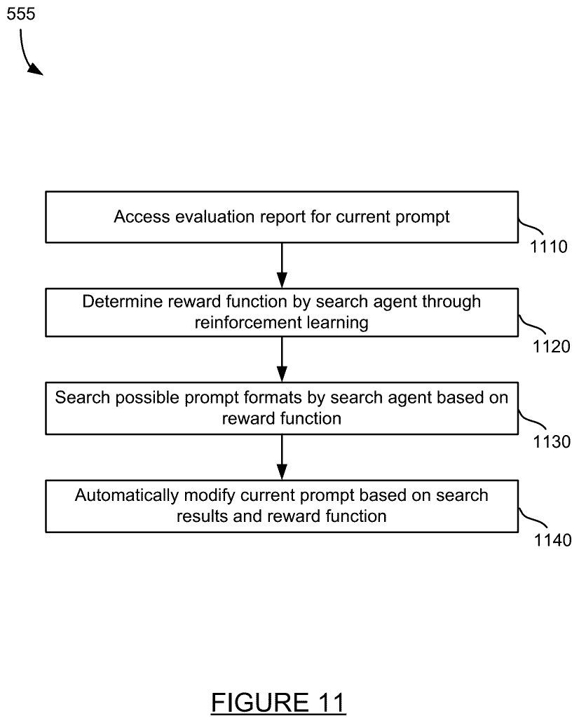

After the evaluation, the current prompt is automatically optimized at step 555. Automatically optimizing the prompt can include searching for templates to improve the prompt based on the evaluation report, selecting the templates, and updating parameters within those templates. In some instances, only prompt parameters marked by a user to be optimized are optimized at step 555. Optimizing a prompt is discussed in more detail with respect to FIG. 11.

FIG. 6 is a method for populating configuration parameters into a prompt renderer interface for a selected node. The method of FIG. 6 provides more detail for step 525 of the method of FIG. 5. A prompt rendering interface template is retrieved at step 610. The retrieved template may be associated with the state or event selected by a user. If no state or event is selected by a user, a template associated with a root node may be selected. For each selection of a subsequent state or event received from a user, the corresponding template may be retrieved at step 610.

Default configuration parameters may be retrieved at step 620. Default configuration parameters may include parameters that are included in all interface templates. Examples of default templates can include whether or not to retrieve instructions, what LLM to submit the prompt to, what language to render a program in a prompt, and a temperature parameter,

State specific configuration parameters may then be retrieved at step 630. State specific configuration parameters include parameters that are chosen to include in the interface based on the selected state or event. Example of a state specific configuration parameters include what portions of an interaction history to include in the prompt, and parameters associated with decision states within a state machine. The interface is then populated with the retrieved parameters at step 640.

FIG. 7 illustrates a method for receiving an input provided to a user interface. The method of FIG. 7 provides more detail for step 530 of the method of FIG. 5. Input related to instructions is at step 710. Input related to instructions can include parameters for the number of instructions to receive, instruction selection mechanism, how to list the instructions in the prompt, and so forth. Input related to examples is received at step 720. Input related to examples can include parameters for the number of examples to receive, an example selection mechanism, and how to list the examples in the prompt. Input for other parameters in the rendering interface is received at step 730. Input may be received through the interface in the form of, for example, selection of a check box, radio button selection, moving a sliding bar, and text boxes.

FIG. 8 illustrates a method for rendering a prompt for a selected state. The method of FIG. 8 provides more detail for step 535 of the method of FIG. 5. Examples are determined and retrieved based on input and parameters at step 810. The parameters may specify how many examples to obtain, the example selection criteria, the location of the examples, and other example related parameters. The instructions are determined and retrieved based on parameters at step 820. Several interface parameters may affect what instructions are received, including but not limited to parameters regarding a selection mechanism for the instructions, the number of instructions to retrieve, and how the instructions will be presented in the prompt. A prompt is rendered based on the retrieved examples, instructions, other prompt parameters, and conversation history for the selected state at step 830.

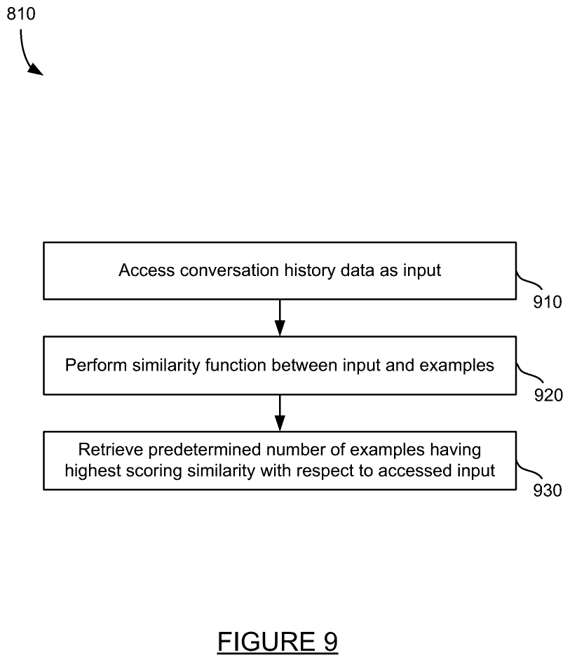

FIG. 9 illustrates a method for determining and retrieving examples based on input and parameters. The method of FIG. 9 provides more detail for step 810 of the method of FIG. 8. Conversation history data is accessed as input at step 910. The conversation history can include text exchanged between an automated agent and a client application and a list of events associated with the automated agent processing (e.g., functions predicted, called, and responses generated).

A similarity function is performed between the input and examples at step 920. The similarity function can be performed as an information retrieval metric, such as BM25. In some instances, the system may take the input embedded as a vector and perform a cosine similarity function with embeddings of all the examples in the database. A predetermined number of examples having the highest scoring similarity with respect to the accessed input, or conversation history data, can be retrieved at step 930.

FIG. 10 illustrates a method for evaluating input and output. The method of FIG. 10 provides more details for step 550 of the method of FIG. 5. A machine learning model output is accessed at step 1010. The output is provided by an LLM that has processed the rendered prompt. A selected number of known good input and output examples are evaluated at step 1020. The known good input and output examples are evaluated against the rendered prompt and actual output to get an accuracy measure at step. An accuracy measure may be reported through the prompt rendering interface at step 1030. Next, accuracy measures are stored for the model, the rendered output, and the actual output at step 1040.

FIG. 11 illustrates a method for optimizing a prompt. The method of FIG. 11 provides more detail for step 555 of the method of FIG. 5. An evaluation report generated for the current prompt is accessed at step 1110. A reward function is determined by a search agent through reinforcement learning at step 1120. The search agent may be implemented by prompt optimization module 280 of FIG. 2. Possible prompt formats are then searched by the search agent based on the reward function at step 1130. The current prompt is then automatically modified based on the search results and the reward function at step 1140. In some instances, only portions of the prompt selected by a user for optimization are optimized according to the method of FIG. 11. In some instances, all portions of the prompt that can be improved are optimized according to the method of FIG. 11.

FIG. 12 illustrates an interface 1200 for selecting a state within a state machine associated with an interaction between an automated agent and a customer. The interface of FIG. 12 illustrates an interaction, in the form of an exchange of text messages, between an automated agent and a customer. The interface 1200 of FIG. 12 also displays a sequential illustration of state machine events. Some of the events listed in the interface are associated with calls to a language model. The language model call events may be selected by a user, and a prompt rendering interface is populated based on the call event selection. For example, the third event listed in the events column is selectable, and is currently being selected by cursor 1210.

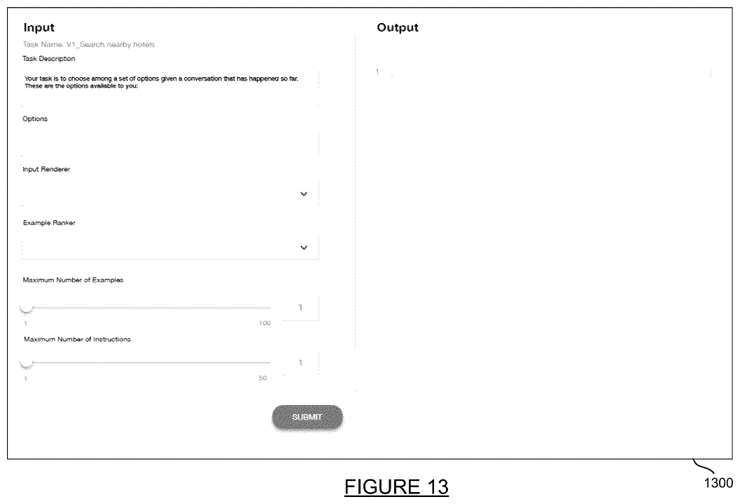

FIG. 13 illustrates an interface 1300 associated with a selected state. The interface of FIG. 13 associated with the selected state includes parameters of task description, options, input renderer, example rancor, maximum number of examples, and maximum number of instructions. The test description includes a text entry within a text box. The input renderer and example rancor are both drop-down menus for selecting a particular type of input renderer and example rancor, respectively. The maximum number of examples can be selected by moving a slider between a value of one and 100. The maximum number of instructions may also be selected by moving the slider to values between one and 100. The interface 1300 also allows for the output of the prompt generated by the particular parameters to be displayed. The output can be displayed after the parameters are selected and a user selects the submit button within the interface 1300.

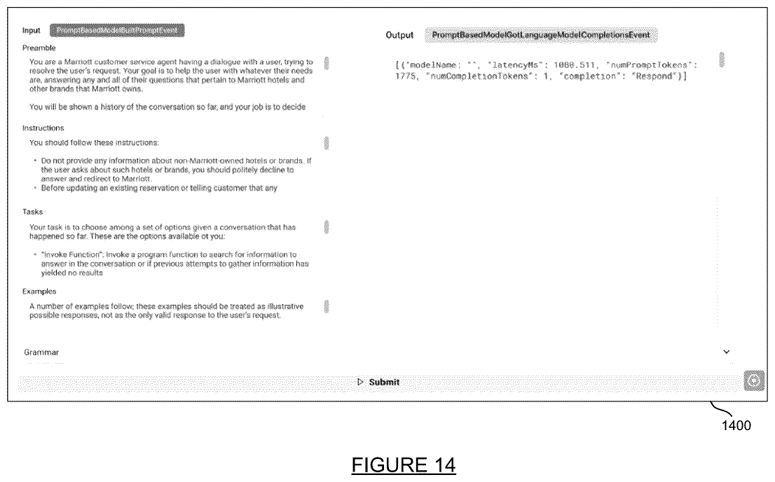

FIG. 14 illustrates a rendered prompt associated with a selected state. The rendered prompt of interface 1400 includes an input, preamble, instructions, tasks, examples, and a grammar. The output indicates a particular event and output. The input associated with the prompt is associated with an interaction between an automated agent and a user. The preamble of the input gives background information to the language model. The instructions and examples are listed consecutively and are in a bulleted format. The task is also listed in a bullet format. The output of the rendered prompt is provided with a name and code that represents the output of the LLM that processed the rendered prompt.

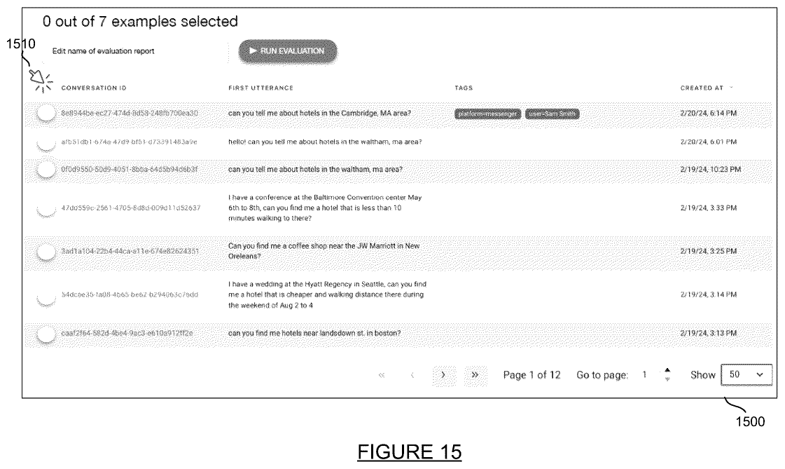

FIG. 15 illustrates an interface displaying a set of examples associated with a current input and output. The interface 1500 of FIG. 15 lists a number of selectable examples that can be used to execute an evaluation for the current prompt and associated output. This evaluation interface allows a user to provide a name of the evaluation report and select a series of examples. Each example is associated with a conversation identifier, a first utterance, tags, and the creation date.

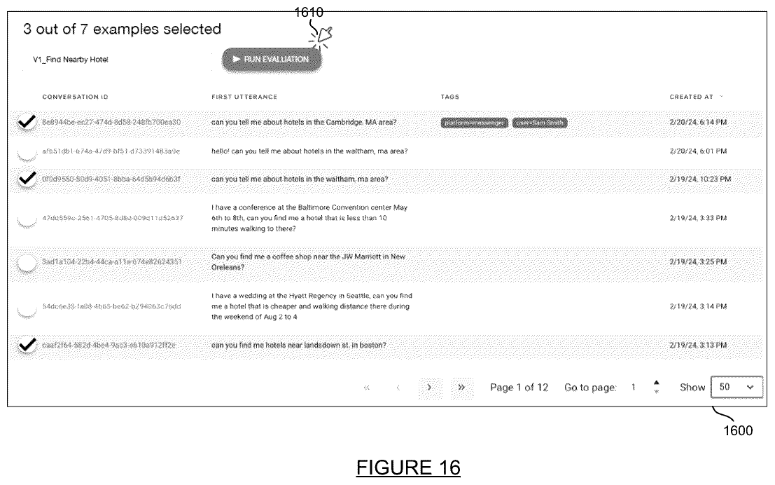

FIG. 16 illustrates an interface with a subset of selected examples associated with a current input and output. FIG. 16 shows the interface of FIG. 15 with the first, third, and seventh example selected. A cursor 1610 is positioned to select a button for executing an evaluation with the three examples selected.

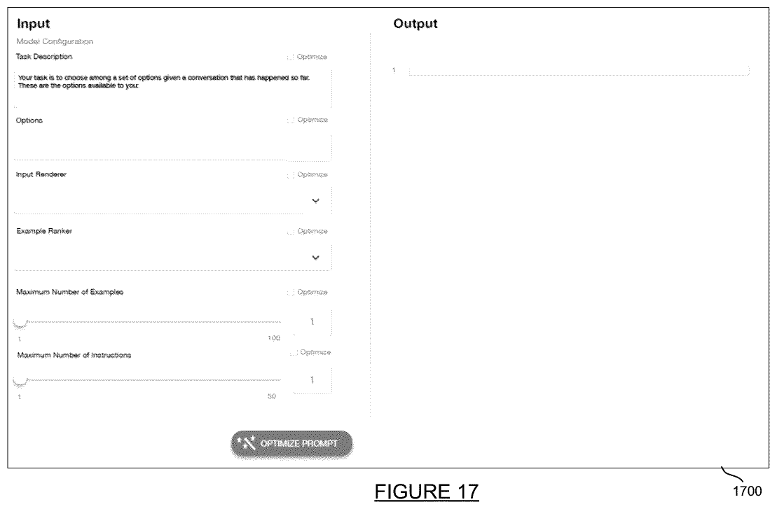

FIG. 17 illustrates an interface for optimizing a prompt. After executing the evaluation, interface 1700 of FIG. 17 can be used to optimize particular parameters associated with the prompt in the current selected state. For each parameter illustrated, a checkbox is provided to allow user to select to optimize that particular parameter.

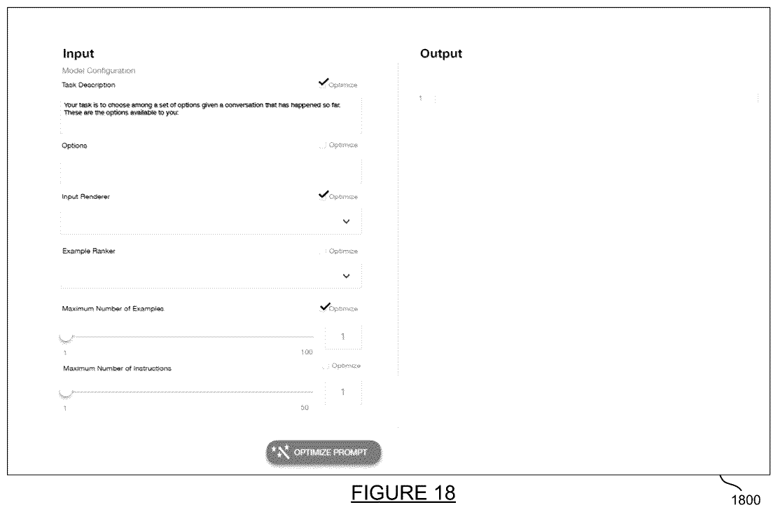

FIG. 18 shows another interface for optimizing a prompt. FIG. 18 illustrates the interface of FIG. 17, with parameters of task description, input renderer, and the maximum number of examples selected for optimization. The selections are made by checking a box next to the particular parameter. The user may initiate optimization by selecting the “optimize prompt” button at the bottom of interface 1800.

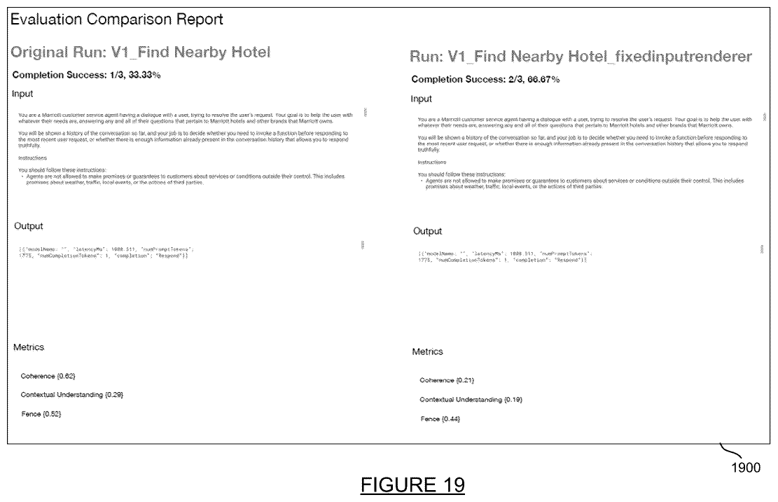

FIG. 19 illustrates an evaluation comparison report. Interface 1900 of FIG. 19 illustrates an evaluation comparison report between a first run (e.g., a first rendering of a prompt and submission of the prompt to an LLM) and a subsequent run for the prompt after the prompt has been evaluated and optimized. In the evaluation comparison report, the original run and subsequent run are illustrated along with the input and the output for each run.

The evaluation metrics for the second run have improved over the evaluation metrics for the first run. The original run has a completion success of one third while the subsequent run has a completion success of two thirds. The metrics for the first run include a coherent score of 0.62, contextual understanding of 0.29, and a fence value 0.52. The subsequent run includes metrics of coherence having a value of 0.21, a contextual understanding of 0.19, and a fence score of 0.44.

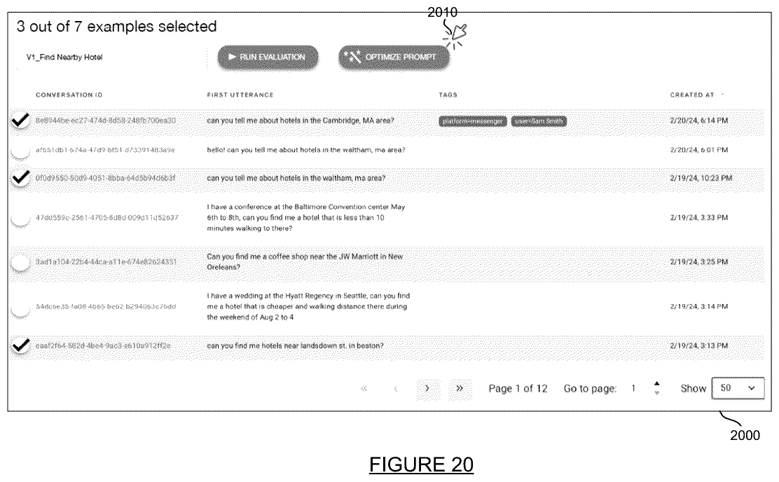

FIG. 20 illustrates an interface with selected examples for optimizing a prompt. Interface 2000 of FIG. 20 is associated with the V1_find nearby hotel state. For the particular state, three examples are selected and a selectable button for optimizing the prompt is being selected by cursor 2010. Upon receiving a selection to optimize the prompt, the examples will be used to optimize the selected parameters for the prompt at the particular state.

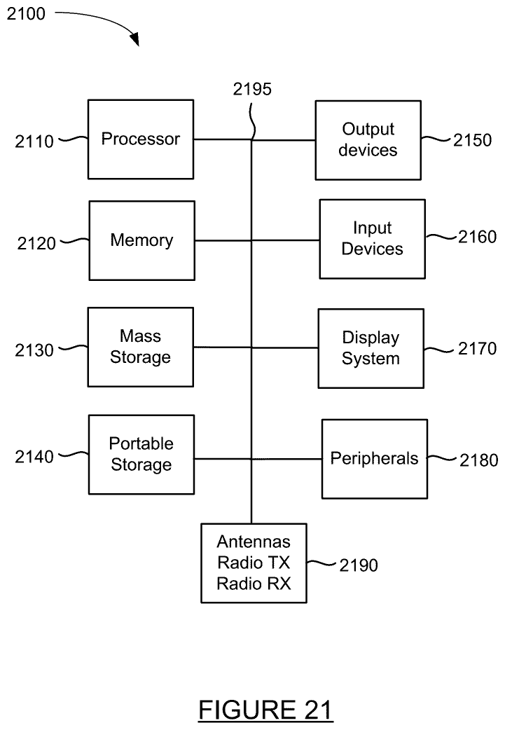

FIG. 21 is a block diagram of a computing environment for implementing the present technology. System 2100 of FIG. 21 may be implemented in the contexts of the likes of machines that implement machine learning model 110, LM server 120, interaction application server 130, client device 140, vector DB 150, and servers 160-170. The computing system 2100 of FIG. 21 includes one or more processors 2110 and memory 2120. Main memory 2120 stores, in part, instructions and data for execution by processor 2110. Main memory 2120 can store the executable code when in operation. The system 2100 of FIG. 21 further includes a mass storage device 2130, portable storage medium drive(s) 2140, output devices 2150, user input devices 2160, a graphics display 2170, and peripheral devices 2180.

The components shown in FIG. 21 are depicted as being connected via a single bus 2195. However, the components may be connected through one or more data transport means. For example, processor unit 2110 and main memory 2120 may be connected via a local microprocessor bus, and the mass storage device 2130, peripheral device(s) 2180, portable storage device 2140, and display system 2170 may be connected via one or more input/output (I/O) buses.

Mass storage device 2130, which may be implemented with a magnetic disk drive, an optical disk drive, a flash drive, or other device, is a non-volatile storage device for storing data and instructions for use by processor unit 2110. Mass storage device 2130 can store the system software for implementing embodiments of the present invention for purposes of loading that software into main memory 2120.

Portable storage device 2140 operates in conjunction with a portable non-volatile storage medium, such as a floppy disk, compact disk or Digital video disc, USB drive, memory card or stick, or other portable or removable memory, to input and output data and code to and from the computer system 2100 of FIG. 21. The system software for implementing embodiments of the present invention may be stored on such a portable medium and input to the computer system 2100 via the portable storage device 2140.

Input devices 2160 provide a portion of a user interface. Input devices 2160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 2100 as shown in FIG. 21 includes output devices 2150. Examples of suitable output devices include speakers, printers, network interfaces, and monitors.

Display system 2170 may include a liquid crystal display (LCD) or other suitable display device. Display system 2170 receives textual and graphical information and processes the information for output to the display device. Display system 2170 may also receive input as a touch-screen.

Peripherals 2180 may include any type of computer support device to add additional functionality to the computer system. For example, peripheral device(s) 2180 may include a modem or a router, printer, and other device.

The system of 2100 may also include, in some implementations, antennas, radio transmitters and radio receivers 2190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 2100 of FIG. 21 are those typically found in computer systems that may be suitable for use with embodiments of the present invention and are intended to represent a broad category of such computer components that are well known in the art. Thus, the computer system 2100 of FIG. 21 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for automatically rendering a prompt, comprising:
providing, by a server, an interface for configuring a set of parameters used to render a prompt, the prompt to be submitted to a machine learning model provided by one or more remote servers;
receiving a selection to modify at least one parameter within the interface; and
rendering the prompt from the set of parameters with at least one modified parameter, wherein a plurality of the parameters are used to format the prompt but are not directly entered into the prompt.

2. The method of claim 1, further comprising receiving a selection of a state within a state machine having a plurality of states, the interface provided from a template associated with the selected state, wherein two or more of the states of the plurality of states have different interface templates.

3. The method of claim 2, wherein the state machine is associated with logic followed by an automated agent during an interaction with a customer associated with a remote device.

4. The method of claim 1, wherein rendering the prompt includes retrieving one or more instructions to include in the rendered prompt based on two or more parameters related to selecting the instructions.

5. The method of claim 1, wherein rendering the prompt includes retrieving one or more examples to include in the rendered prompt based on two or more parameters related to selecting the examples.

6. The method of claim 1, further comprising evaluating the rendered prompt and an output by an LLM that processed the prompt to generate the output.

7. The method of claim 6, further comprising automatically optimizing the rendered prompt in response to an evaluation report generated from the evaluating and one or more pairs of an example prompt and an output of an LLM that processed the example prompt.

8. A non-transitory computer readable storage medium having embodied thereon a program, the program being executable by a processor to automatically render a prompt, the method comprising:
providing, by a server, an interface for configuring a set of parameters used to render a prompt, the prompt to be submitted to a machine learning model provided by one or more remote servers;
receiving a selection to modify at least one parameter within the interface; and
rendering the prompt from the set of parameters with at least one modified parameter, wherein a plurality of the parameters are used to format the prompt but are not directly entered into the prompt.

9. The non-transitory computer readable storage medium of claim 8, the method further comprising receiving a selection of a state within a state machine having a plurality of states, the interface provided from a template associated with the selected state, wherein two or more of the states of the plurality of states have different interface templates.

10. The non-transitory computer readable storage medium of claim 9, wherein the state machine is associated with logic followed by an automated agent during an interaction with a customer associated with a remote device.

11. The non-transitory computer readable storage medium of claim 8, wherein rendering the prompt includes retrieving one or more instructions to include in the rendered prompt based on two or more parameters related to selecting the instructions.

12. The non-transitory computer readable storage medium of claim 8, wherein rendering the prompt includes retrieving one or more examples to include in the rendered prompt based on two or more parameters related to selecting the examples.

13. The non-transitory computer readable storage medium of claim 8, the method further comprising evaluating the rendered prompt and an output by an LLM that processed the prompt to generate the output.

14. The non-transitory computer readable storage medium of claim 13, the method further comprising automatically optimizing the rendered prompt in response to an evaluation report generated from the evaluating and one or more pairs of an example prompt and an output of an LLM that processed the example prompt.

15. A system for automatically rendering a prompt, comprising:
one or more servers, wherein each server includes a memory and a processor; and
one or more modules stored in the memory and executed by at least one of the one or more processors to provide, by a server, an interface for configuring a set of parameters used to render a prompt, the prompt to be submitted to a machine learning model provided by one or more remote servers, receive a selection to modify at least one parameter within the interface; and render the prompt from the set of parameters with at least one modified parameter, wherein a plurality of the parameters are used to format the prompt but are not directly entered into the prompt.

16. The system of claim 15, the modules further executable to receive a selection of a state within a state machine having a plurality of states, the interface provided from a template associated with the selected state, wherein two or more of the states of the plurality of states have different interface templates.

17. The system of claim 16, wherein the state machine is associated with logic followed by an automated agent during an interaction with a customer associated with a remote device.

18. The system of claim 15, wherein rendering the prompt includes retrieving one or more instructions to include in the rendered prompt based on two or more parameters related to selecting the instructions.

19. The system of claim 15, wherein rendering the prompt includes retrieving one or more examples to include in the rendered prompt based on two or more parameters related to selecting the examples.

20. The system of claim 15, the modules further executable to evaluate the rendered prompt and an output by an LLM that processed the prompt to generate the output.
